(19) United States
(12) Patent Application Publication
(10) Pub. No.: US 2020/0170448 A1
(43) Pub. Date: Jun. 4, 2020

(54) SPRITZER ASSEMBLY

(71) Applicant: GMG Products LLC, Lakeside, OR (US)

(72) Inventors: David W. BAKER, Lakeside, OR (US); Jason BAKER, Scottsdale, AZ (US)

(21) Appl. No.: 16/209,702

(22) Filed: Dec. 4, 2018

(51) Int. Cl. A47J 37/07

(52) U.S. Cl. CPC A47J 37/0786; F24B 1/10; A47J 37/0704

(57) ABSTRACT

A spritzer assembly for a cooking device is provided herein. The spritzer assembly includes a reservoir configured to maintain a fluid therein. A pump is operably coupled with the reservoir. The pump is configured to move the fluid from the reservoir and through a nozzle. The nozzle is configured to be positioned within a heating chamber. A controller is configured to selectively activate the pump.

### FIELD OF THE INVENTION

The present disclosure generally relates to a spritzer assembly for a cooking device.

### BACKGROUND OF THE INVENTION

Various liquids can be applied to food items as the food item is cooked. For some cooking devices, it may be desirable to have a spritzer assembly to accomplish this task.

### SUMMARY OF THE INVENTION

According to some examples of the present disclosure, a spritzer assembly for a cooking device is provided herein. The spritzer assembly can includes a reservoir configured to maintain a fluid therein. A pump is operably coupled with the reservoir, the pump configured to move the fluid from the reservoir and through a nozzle. The nozzle is configured to be positioned within a heating chamber. A controller is configured to selectively activate the pump.

According to some examples of the present disclosure, a cooking device includes a housing defining a heating chamber and a void within the housing. A spritzer assembly has a pump operably coupled with a reservoir and a nozzle. The nozzle is disposed within the heating chamber and operably coupled to the pump through a tubing disposed through the void. A controller is operably coupled with the pump and configured to selectively activate the pump to move a fluid from the reservoir through the nozzle.

According to some examples of the present disclosure, a spritzer assembly for a cooking device is provided herein. The spritzer assembly includes a reservoir configured to maintain a fluid therein. A pump is operably coupled with the reservoir. The pump moves the fluid from the reservoir and through first and second nozzles. The first and second nozzles are configured to be positioned within a heating chamber and are fluidly coupled to one another. A controller is configured to selectively activate the pump. The controller is further configured to operably couple with an electronic device.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a front perspective view of a cooking device having a fuel and a heating element for heating a heating chamber, according to some examples;

FIG. 2 is a front perspective view of the cooking device having a lid disposed in an open position and a spritzer assembly operably coupled with the heating chamber, according to some examples;

FIG. 3 is a side perspective view of the cooking device with a reservoir and a pump of the spritzer assembly disposed adjacently to the heating chamber, according to some examples;

FIG. 4 is perspective view of the spritzer assembly operably coupled with a remote electronic device and an input device, according to some examples;

FIG. 5 is a perspective view of the spritzer assembly having a dedicated power supply, according to some examples;

FIG. 6 is a cross section of a first nozzle of the spritzer assembly, according to some examples, taken along the line VI-VI of FIG. 4;

FIG. 7 is a cross section of a second nozzle of the spritzer assembly, according to some examples, taken along the line VII-VII of FIG. 4;

FIG. 8 is a block diagram illustrating the cooking assembly and the spritzer assembly having a dedicated controller, according to some examples;

FIG. 9 is a block diagram illustrating the cooking assembly and the spritzer assembly having a shared control unit, according to some examples; and

FIG. 10 is a block diagram of the cooking device operably coupled with a remote server, according to some examples.

### DETAILED DESCRIPTION OF THE PREFERRED EXAMPLES

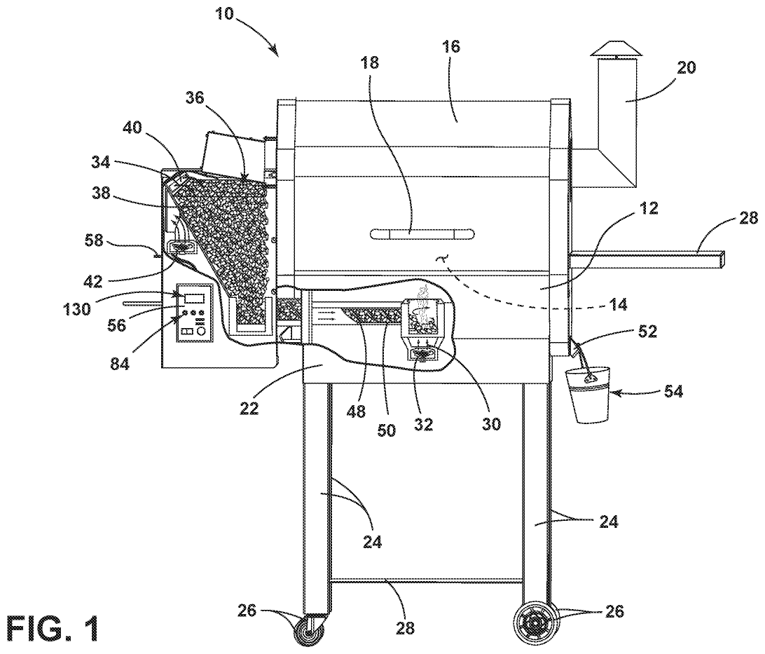

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

The following disclosure describes a spritzer assembly for a cooking device. The spritzer assembly can include a reservoir configured to maintain a fluid therein. A pump can be operably coupled with the reservoir. The pump can be configured to move the fluid from the reservoir and through a nozzle. The nozzle is configured to be positioned within a heating chamber. A controller is configured to selectively activate the pump. The controller is operably coupled with an electronic device and/or an input device that may be be configured to accept instructions. In turn, the controller can selectively activate the pump for at least one of a predetermined duration and a predetermined time frequency based on the instructions.

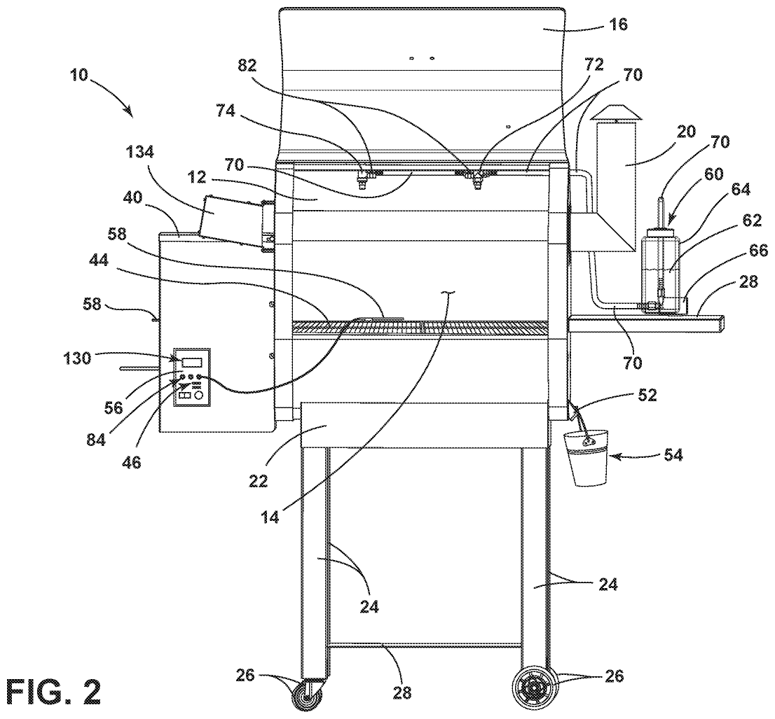

Referring to FIGS. 1 and 2, a cooking device 10 includes a housing 12 that defines a heating chamber 14 in which food items to be prepared may be placed. In some examples, the housing 12 includes a movable lid 16 for providing and inhibiting access to the heating chamber 14. A handle 18 can be positioned on the lid 16 to enable a user to move the lid 16 between a closed position, as exemplarily illustrated in FIG. 1, and an open position, as exemplarily illustrated in FIG. 2. In some examples, the cooking device 10 may include one or more racks 44 upon which an item may be placed. During operation, the lid 16 can be closed so as to retain heat and/or smoke supplied to the heating chamber 14 for food preparation. The cooking device 10 may also include one or more exhaust conduits 20 to remove heat and/or smoke from the heating chamber 14. The exhaust conduit 20 may be selectively closed and/or altered to adjust the heating characteristics within the chamber 14.

The housing 12 may be coupled to a support structure 22 that includes one or more legs 24. Any of the legs 24 may be operably coupled with a swivel caster and/or a wheel 26 to facilitate movement of the cooking device 10. A shelf 28 may be operably coupled with the support structure 22 and/or supported by one or more of the legs 24. Additionally, and/or alternatively, the shelf 28 may be operably coupled with the housing 12 and extend therefrom. It will be appreciated that the cooking device 10 may be any type of cooking device. As non-limiting examples, the cooking device 10 may a grill, smoker, air fryer, oven, brazier, steamer, roaster, fryer, broiler, stove, and/or toaster oven. While the cooking device 10 may be any type of cooking device 10, the present disclosure will be described with continuing reference to a grill, which may utilize pellets 38 as the fuel 34. Those of ordinary skill in the art will be able to apply the features set forth herein to other types of cooking devices 10 using the description of the present disclosure in the non-limiting example of a grill.

Various components of the cooking device 10 may be made of any desired heat resistant material(s). As non-limiting examples, various portions of the cooking device 10 may be made of stainless steel and/or cast iron. The cooking device 10 can be shaped to have an enclosed inner chamber, i.e., the heating chamber 14, which may be heated by a heat source 30. The heat source 30 can include a heating element 32 that may independently produce heat. Additionally, and/or alternatively, the heating element 32 may ignite a fuel 34 and/or sustain a burning of the fuel 34 to produce heat within the heating chamber 14, which may occur in a burn box. Additionally, and/or alternatively, still, the heating element 32 may be replaced, or supplemented with, with an ignitor that may ignite the fuel 34 to produce heat within the heating chamber 14 in examples in which a liquid and/or a gas fuel 34 is utilized.

In some examples, the fuel 34 may be stored in a hopper 36, or any other type of container, and may contain wood pellets 38 for producing the heat and/or smoke. In some instances, the pellets 38 are loaded into the hopper 36 through movement of a panel 40 from a closed position to an open position thereby providing access into the hopper 36. The pellets 38 may be transported from the hopper 36 using a channel 48 and an auger 50. The auger 50 may be centrally disposed in the channel 48 that may run along an underside of the heating chamber 14. The channel 48 includes openings or the like that place the channel 48 and/or the auger 50 in gaseous communication with the heating chamber 14. When the auger 50 is rotated within the channel 48, pellets 38 are drawn from the hopper 36 and transported via the auger 50 through the channel 48. One or more heating elements 32 (e.g., electrical heating elements) locally heat the wood pellets 38 and cause the pellets 38 to emit heat and/or smoke for the heating chamber 14. After the consumption of the pellets 38, the channel 48 and the auger 50 further transport the consumed pellets 38 (or remains thereof) to a used pellet discharge port 52. At the used pellet discharge port 52, the pellets 38 can exit the cooking device 10. In some instances, a bucket 54, container, tray, or the like may be disposed at the used pellet discharge port 52 to collect the pellet remains.

It will be appreciated that the cooking device 10 of the present disclosure may use any desired fuel 34 for heating the heating chamber 14. As non-limiting examples, the fuel 34 for the cooking device 10 may be wood (e.g., wood pellets), stick burners, natural gas, charcoal, gas, and/or an electrical heating unit. The heat source 30 may sustain a temperature inside the cooking device 10 of around 100 to 800 degrees Fahrenheit for cooking the food items. In some examples, the cooking device 10 may be able to automatically (without human intervention) regulate the temperature inside the cooking device 10 to a predetermined set temperature or temperature range.

With further reference to FIGS. 1 and 2, a control unit 56 for controlling operation of the cooking device 10 may house, be integrated within, or otherwise installed on the hopper 36. However, it will be appreciated that the control unit 56 may be disposed on any portion of the cooking device 10 and/or remotely coupled with the cooking device 10 without departing from the teachings provided herein. In some instances, the control unit 56 can control the auger 50 and/or operation of the heating elements 32. However, the control unit 56 may perform other functions and it is also contemplated that the cooking device 10 may have multiple control units 56 at various locations, which may be tethered to or remotely positioned from the cooking device 10.

The control unit 56 may further include a display 130 for displaying the status of the operation of the cooking device 10, an input device 84 for accommodating user input, a cabinet temperature sensor for determining the temperature inside the chamber 14, a probe 58 for determining the internal temperature of the food being cooked, a timer module for setting the cooking time for the cooking device 10, a probe temperature set module for setting the internal temperature of the food product based on the user's preference for the cooked food, a display control relay for powering the display and input device 84, and/or a heat source control relay for cycling the heat source 30 on and off. The probe 58 may be electronically coupled with one or more input/output (I/O) ports 46 disposed on the control unit 56. The I/O ports 46 may be configured in any manner and may interact and/or couple with a wide array of devices.

Still referring to FIGS. 1 and 2, a spritzer assembly 60 may be operably coupled with the chamber 14 to deliver a fluid solution 62 to the heating chamber 14. The spritzer assembly 60 may include a reservoir 64, a pump 66, piping or tubing 70, and one or more nozzles 72, 74. The spritzer assembly 60 can deliver various types of solutions 62 that can alter the flavor of the food item, increase moisture within the food item, increase cooking efficiency of the food item, and/or provide other various benefits while the food item is positioned within the heating chamber 14. In some examples, the fluid solution 62 that can be used with the spritzer assembly 60 include water based solutions, juice based solutions, vinegar based solutions, fermented solutions, and/or other types of seasoning solutions as desired. The solution 62 can be contained within the reservoir 64 and can be refilled by a user. Alternatively, the reservoir 64 can be a replaceable cartridge that can be removed from the spritzer assembly 60 and replaced as desired. The replaceable cartridge may have any standard or proprietary attachment such that the user may be able to ensure the origination of the replaceable cartridge.

In some instances, each of the components of the spritzer assembly 60 can be constructed from a metallic material (e.g., stainless steel, steel, aluminum, etc.), an elastomeric material (e.g., rubber), a polymeric material (e.g., silicone) and/or other materials. The components of the spritzer assembly 60 can be positioned in any one of a multitude of possible locations, such as, on the shelf 28 of the cooking device 10, as shown in FIG. 2, on and/or within the control unit 56, on and/or within the hopper 36, on and/or within the housing 12 of the cooking device 10, or in other suitable locations. In some examples, the pump 66, the reservoir 64, and/or the power supply 92 are not contained within a predefined location, but rather are individually located within or adjacent to the cooking device 10.

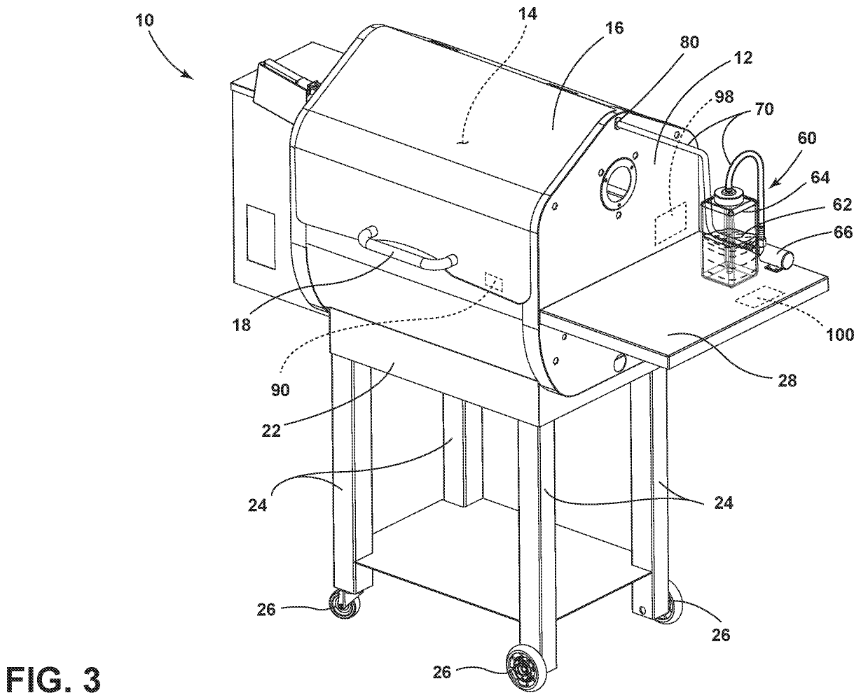

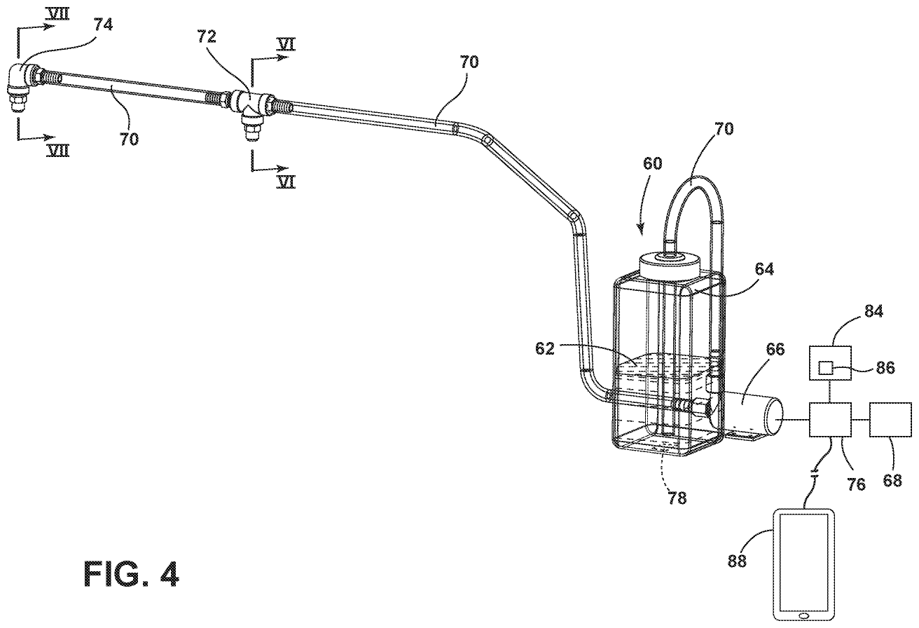

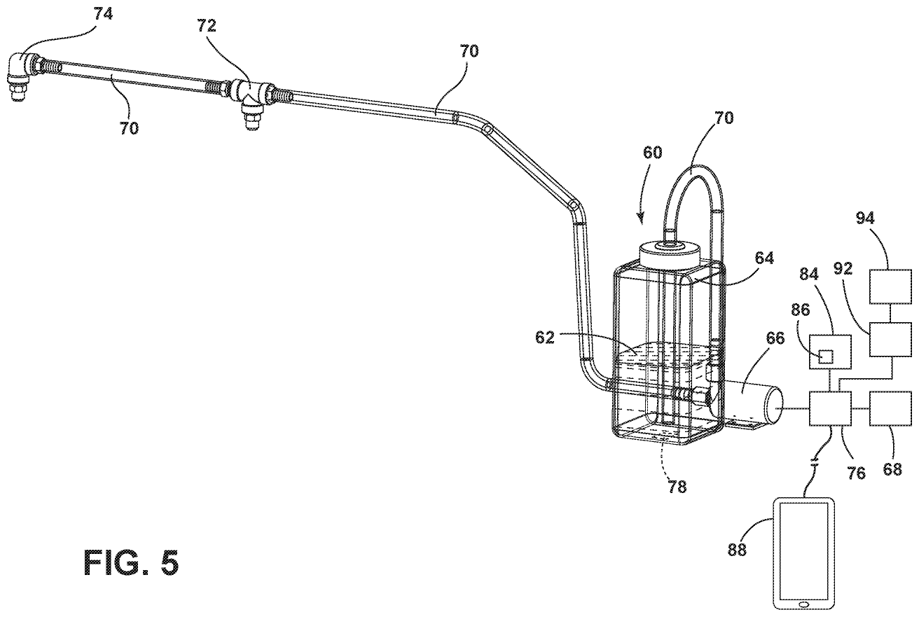

Referring now to FIGS. 3 and 4, the spritzer assembly 60 may include a controller 76 electronically coupled to a power source 68 and/or a power supply (FIG. 5). The controller 76 is configured to receive various inputs and control the pump 66 by applying signals to the pump 66. The controller 76 may be disposed within the spritzer assembly 60, the control unit 56, the hopper 36, and/or any other portion of the cooking device 10. In some examples, the controller 76, and consequently, the pump 66 may be powered by a port 46 disposed on the control unit 56. The port 46 may be configured as a universal serial bus (USB) port in some implementations. In instances in which the controller 76 receives power from the control unit 56, various user preferences and/or instructions may be inputted through the input device 84 of the control unit 56 for activation/deactivation of the pump 66. In some instances, power may be provided to the spritzer assembly 60 from power sources remotely disposed form the cooking device power, such as plugging the spritzer assembly 60 into an electrical outlet thereby coupling the grid. In some instances, the pump 66 can be gravity fed, hand operated, or pre-pressurized, such that the spritzer assembly 60 is free from a power source 68 and/or operable without use of the power source 68.

With further reference to FIGS. 3 and 4, the pump 66 can be any fluid pump capable of transporting a fluid solution 62 from the reservoir 64 to at least one nozzle 72, 74. In various examples, the pump 66 can be configured as an electric pump, a gravity fed system, a hand operated pump, a pre-pressurized pump, and/or any other type of practicable pump. The reservoir 64 can contain a fluid solution 62 until received by the pump 66, and the capacity of the reservoir 64 can vary with the size of the cooking device 10 and/or as desired by a user. In some examples, the spritzer assembly 60 can include a low fluid sensor 78 coupled to the reservoir 64 and the spritzer assembly 60 and/or the cooking device 10 may be capable of providing notifications when the fluid level within the reservoir 64 is below a predefined amount of fluid solution 62.

One or more sections of tubing 70 can be coupled to the pump 66 for transporting the fluid from the pump and/or the reservoir 64 to the nozzles 72, 74. The tubing 70 can be constructed from silicone, stainless steel, steel, aluminum, rubber, plastic, or other materials as desired by a user. The tubing 70 can be disposed through a void 80 defined by the housing 12 and supported within the heating chamber 14 by one or more brackets 82 (FIG. 2). Additionally or alternatively, the tubing 70 may also be welded, bonded, latched, and/or otherwise secured to and/or supported within the heating chamber 14. The tubing 70 may be extendable and/or be formed of a sufficient length such that the pump 66 and/or reservoir 64 may stay in a substantially constant position when the lid 16 of the cooking device 10 is moved between the closed position and an open position in examples in which the nozzle may be coupled to the lid 16. Moreover, in some examples, the housing 12 may include a cover that is positioned over the void 80 when the tubing 70 is removed from therefrom.

In some examples, the tubing 70 can be fluidly coupled to at least one nozzle 72, 74 for producing a mist within the heating chamber 14. In some instances, the nozzles 72, 74 can additionally or alternatively produce a spray, jet, wash, droplets, or other forms of liquid as desired to the heating chamber 14. The nozzles 72, 74 can comprise misters, sprinklers, atomizers, mist generators, and/or any other device configured to direct fluids in a predefined manner. The nozzles 72, 74 can produce a preset level of mist/moisture or the nozzles 72, 74 can be modified by the user to produce more or less mist/moisture.

The controller 76 may be operably coupled with the input device 84, which may be disposed within the control unit 56 and/or the spritzer assembly 60. The input device 84 may be configured to accept instructions as to at least one of a predetermined duration and a predetermined time frequency to initiate the pump 66 and the controller 76 may activate and deactivate the pump 66 based on those instructions. In some instances, a user may define a frequency upon which the pump 66 can be activated and deactivated. Additionally or alternatively, when the input device 84 is not utilized and/or instructions are not provided by a user, the input device 84 or the controller 76 may activate/deactivate the pump 66 based on a default frequency. As one non-limiting example, some food items might take several hours to smoke, and during this period, a user may generally want to spritz the food item every 20-30 minutes. The application 128 can allow the user to automate that procedure possibly without having to have physical presence at the cooking device 128.

Additionally, the input device 84 may further include a switch 86 thereon such that the user may activate/deactivate the pump 66 by manually toggling the switch 86 between a first state and a second state. It will be appreciated that the switch 86 may be any type of switch 86 without departing from the scope of the present disclosure. For example, the switch 86 may be configured as a proximity switch that provides a sense activation field to sense contact or close proximity (e.g., within one millimeter) of an object, such as the hand (e.g., palm or finger(s)) of a user in relation to the switch 86. It will be appreciated by those skilled in the art that proximity switches of any type can be used, such as, but not limited to, capacitive sensors, inductive sensors, optical sensors, temperature sensors, resistive sensors, the like, or a combination thereof. It will also be appreciated that the switch 86 may alternatively be a mechanical switch of any type known in the art, such as a push button.

With further reference to FIGS. 3 and 4, in some examples, the cooking device 10 may communicate via wired and/or wireless communication with one or more handheld or electronic devices 88. The communication may occur through one or more of any desired combination of wired (e.g., cable and fiber) and/or wireless communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, cellular, satellite, microwave, and radio frequency, providing data communication services.

The electronic device 88 may be any one of a variety of computing devices and may include a processor and memory. The memory may store logic having one or more routines that is executable by the processor. For example, the electronic device 88 may be a cell phone, mobile communication device, key fob, wearable device (e.g., fitness band, watch, glasses, jewelry, wallet), apparel (e.g., a tee shirt, gloves, shoes or other accessories), personal digital assistant, headphones and/or other devices that include capabilities for wireless communications and/or any wired communications protocols.

In operation, when the cooking device 10 is in use, the spritzer assembly 60 may be configured to activate/deactivate the pump 66 as determined by a user and/or a predetermined routine. If the cooking device 10 is equipped with a door sensor 90, in some instances, the spritzer assembly 60 may pause or cease operation until the door is detected to be in the closed position. Once the spritzer assembly 60 has become operational, the pump 66 may transport the fluid from the reservoir 64 through the tubing 70 and ultimately to the at least one nozzle 72, 74. It will be appreciated, however, that the pump 66 may be activated while the lid 16 is in the open position in some instances. Once the fluid has reached the nozzle 72, 74 the fluid is dispensed into the heating chamber 14 in the form of mist, spray, spritz, etc. towards the food items therein. By spraying the food item within the heating chamber 14, the taste, cooking properties, aesthetics, etc. may be altered. Among other factors, the amount of moisture that is dispensed during each interval can vary with the size of the cooking device 10, the number of nozzles 72, 74, the type of fluid used, and the duration of the spritzing operation.

In some examples, the spritzer assembly 60 disclosed herein can be produced and sold as a retrofit kit. The retrofit kit can allow a user to modify an existing cooking device 10, such that the retrofitted cooking device 10 is capable of delivering the fluid solution to the heating chamber 14. The kit can include a pump 66, a reservoir 64, a power supply 92 (FIG. 5) (and/or a power source attachment), a controller 76 (possibly having a wireless transceiver 126 therein), and/or a user input device 84. In alternative examples, the kit can include a gravity fed, hand operated, or pre-pressurized pump instead of a pump/power supply combination. The kit can also include at least one nozzle 72, 74 and at least one section of tubing 70 to channel the solution 62 between the pump 66 and at least one nozzle 72, 74.

Referring to FIG. 5, the spritzer assembly 60 may additionally or alternatively include a dedicated power supply 92, such as alkaline type batteries, rechargeable batteries, lithium ion, nickel-cadmium, nickel-metal-hydride, button batteries, capacitors, and/or any other suitable power storage device. Additionally, in some examples, the power supply 92 may receive power thereto from one or more generators 94 disposed within and/or on the cooking device 10, the power source 68, and/or from an external power source, such as the grid. The power supply 92 may provide power for at least one of the controller 76 and the pump 66. In some instances, the generator 94 may be configured as a thermoelectric generator 98 (FIG. 3) may be operably coupled with the power source 68 and/or the controller 76 for generation of thermal and electrical energy. The thermoelectric generator 98 may use a temperature gradient, such as between a hot component (e.g., the exhaust conduit 20 and/or a portion of the housing 12) and a lower-temperature space (e.g., ambient air) to provide a temperature difference across one or more thermoelectric conversion elements and thereby generate electricity. In operation, the heating chamber 14 is heated and the generator 98, which may include a plurality of thermoelectric converters may be used to extract electrical energy. The electrical energy generated by thermoelectric conversion may be provided to the power supply 92 (e.g., rechargeable battery, capacitor, etc.) for later use.

Additionally or alternatively, the generator 94 may be configured as a solar panel 100 (FIG. 3) that is configured to convert light into electric energy through the photovoltaic effect. The panel 100 may use wafer-based crystalline silicon cells, thin-film cells, or any other type of device capable of converting light into electrical energy. The panel 100 may be positioned on and/or around the cooking device 10 in any manner. As provided herein, the electrical energy generated by the solar panel 100 may be provided to the power supply 92 (e.g., rechargeable battery, capacitor, etc.) for later use.

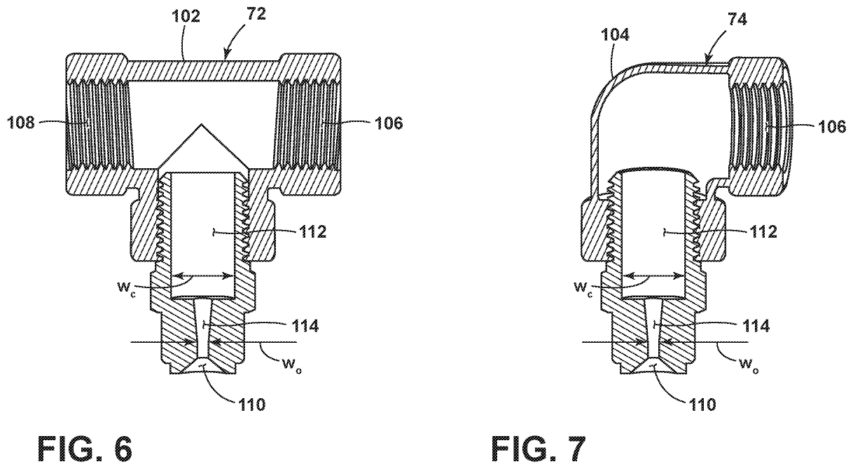

Referring to FIGS. 6 and 7, the first nozzle 72 and the second nozzle 74 may each include a respective frame 102 that defines an inlet 106 and one or more outlets 108, 110. In some examples, the first nozzle 72 may be a three way nozzle in which the nozzle 72 includes an inlet 106 and a pair of outlets 108, 110. The first outlet 108 may be configured as a pass-through that allows fluid to continue through the first nozzle 72, through the tubing 70, and to the second nozzle 74. The second outlet 110 may be configured as a spray outlet that emits the fluid solution 62 in a predefined manner. The second nozzle 74 may be a two way nozzle and can include a single inlet 106 and a single outlet 110. In some instances, the first nozzle 72 generates a first spray pattern and the second nozzle 74 generates a second, differing spray pattern. It will be appreciated, however, that the spritzer assembly 60 may include any number of nozzles 72, 74 (e.g., one or more) having any number of inlets 106 and/or outlets 108, 110 (spray, pass-through, or other type) without departing from the teachings provided herein.

With further reference to FIGS. 6 and 7, each nozzle 72, 74 may produce a cone spray pattern in a finely distributed spray of atomized fluid as the fluid exits each nozzle 72, 74, according to some examples. However, the spritzer assembly 60 may utilize any other type of nozzle 72, 74 and/or spray pattern without departing from the scope of the present disclosure. In some instances, the frame 102, 104 of each nozzle 72, 74 defines an internal fluid chamber 112 between the inlet 106 and the spray outlet 110. An orifice 114 is disposed between the fluid chamber 112 and the spray outlet 110. In some instances, a width we of the fluid chamber 112 is greater than a width wo of the orifice 114. The spray outlet 110 can be positioned at an opposing end of the orifice 114 from the fluid chamber 112. In some instances, the spray outlet 110 may have a “v-notched” shape that may assist in spreading of the flow of the solution 62 there though.

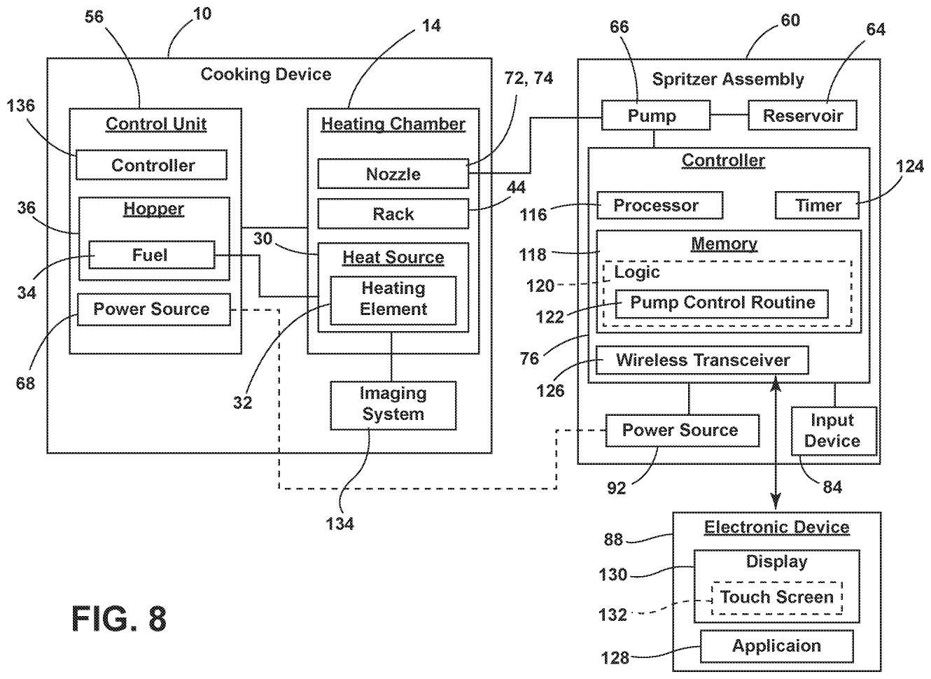

Referring to FIG. 8, in some examples, the cooking device 10 includes the control unit 56 and the heating chamber 14. The hopper 36 may be integrated within the control unit 56 that controls the amount of fuel 34 that is supplied from the hopper 36 to produce heat/smoke within the heating chamber 14 through a cooking device controller 136. The cooking device controller 136 may have any of the features described in regards to the spritzer assembly controller 76 without departing from the scope of the present disclosure. The control unit 56 may be electronically controlled and, thus, includes the power source 68. It will be appreciated, however, that the control unit 56 may be additionally or alternatively include a valve and/or other non-electronically powered device for regulating the fuel 34. In some examples, the fuel 34 may also be disposed within the hopper 36. However, it will be appreciated that the fuel 34 may be otherwise positioned within the cooking device 10 and/or remotely disposed from the cooking device 10 without departing from the teachings of the present disclosure.

The heating chamber 14 defines a space for placing food items in. The heating chamber 14 also may include a heating element 32 or a heat producing device to heat the heating chamber 14 and/or ignite the fuel 34 thereby providing heat/smoke to the heating chamber 14. At least one nozzle 72, 74 of the spritzer assembly 60 may also be disposed within the heating chamber 14. In some instances, the heat source 30 may be on a differing, or opposing, side of the food item from the at least one nozzle 72, 74 while the food item is maintained on the rack 44.

The nozzle 72, 74 of the spritzer assembly 60 is fluidly coupled with the pump 66 and the reservoir 64. The pump 66 is activated and deactivated by a controller 76 that may include a processor 116 and memory 118, according to some examples. Logic 120 is stored within the memory 118 and includes one or more routines, such as a pump control routine 122, which is executed by the processor 116. The controller 76, 136 may further include a timer 124 that can determine operational intervals/frequencies and activation durations of the pump 66. The controller 76 may include any combination of software and/or processing circuitry suitable for controlling the pump 66 described herein including without limitation processors, microcontrollers, application-specific integrated circuits, programmable gate arrays, and any other digital and/or analog components, as well as combinations of the foregoing, along with inputs and outputs for transceiving control signals, drive signals, power signals, sensor signals, and so forth. All such computing devices and environments are intended to fall within the meaning of the term “controller” or “processor” as used herein unless a different meaning is explicitly provided or otherwise clear from the context.

As provided herein, the controller 76 may be programmed to activate/deactivate the pump 66 at discrete frequencies and durations, and/or the pump 66 may be manually actuated through the use of the input device 84 and/or a remote electronic device 88. In addition to the input device 84, the controller 76 may communicate with one or more electronic devices 88 through a wireless transceiver 126. The electronic device 88 may have an application 128 thereon and a display 130 may provide a graphical user interface (GUI) and/or various types of information to a user. The activation of the pump 66 by the controller 76 may be varied through usage of the application 128. The electronic device 88 may likewise have any combination of software and/or processing circuitry suitable for controlling the pump 66 described herein including without limitation processors, microcontrollers, application-specific integrated circuits, programmable gate arrays, and any other digital and/or analog components, as well as combinations of the foregoing, along with inputs and outputs for transceiving control signals, drive signals, power signals, sensor signals, and so forth. For instance, the electronic device 88 may be configured to receive user inputs via touchscreen circuitry 132 on the display 130. The inputs may relate to a type of food item disposed within the heating chamber 14 and may be based on an automatic detection of the food item and/or user provided information as to a type of food item. In response, the application 128 and/or controller 76 may provide suggested spritzing patterns during the duration in which the food item is heated. Accordingly, the activation of the pump 66 by the controller 76 may be varied by a user through usage of the application 128 in addition to or in lieu of usage of the input device 84 and/or a predetermined activation sequence. The spritzing patterns may be based on any variable, including but not limited to, the temperature within the heating chamber 14, the type of food item, the type of fluid utilized within the spritzer assembly 60, user preferences, user instructions, food temperature (which may be measured by the probe 58), etc. As one non-limiting example, some food items might take several hours to smoke, and during this period, a user may generally want to spritz the food item every 20-30 minutes. The application 128 can allow the user to automate that procedure possibly without having to have physical presence at the cooking device 128. In addition, the electronic device 88 may also provide feedback information, such as visual, audible, and tactile alerts. The feedback information may be provided for any reason, including but not limited to, error notifications, pump activation notifications, food item cooked notifications, timing notifications, etc.

In some instances, the cooking device 10 may include an imaging system 134, which is exemplarily illustrated in FIG. 2. In such instances, one or more imagers within the imaging system 134 may include an area-type image sensor, such as a CCD or a CMOS image sensor, and image-capturing optics that captures an image of an imaging field of view defined by the image-capturing optics. The captured image may be illustrated on the display 130 of the electronic device 88. In some instances, successive images may be captured and provided on the display 130 to create a video. The images may be used to monitor the food item, to determine whether to activate/deactivate the pump 66, to verify the spritzer assembly 60 is functioning, and/or for any other purpose.

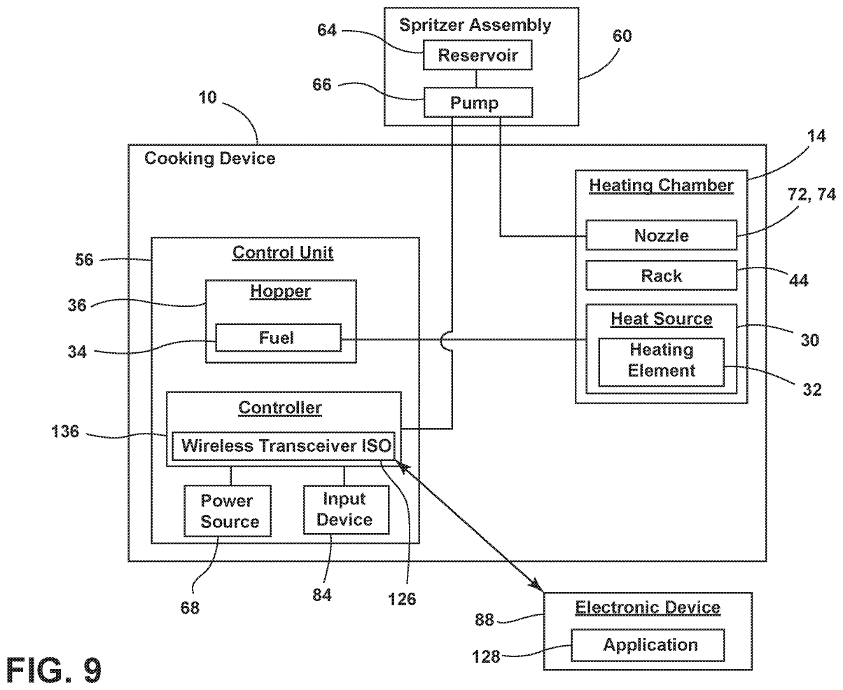

Referring to FIG. 9, in some examples, a controller 136 of the control unit 56 may also control the pump 66 of the spritzer assembly 60. In some instances, the control of the pump 66 may occur through a wired connection of the pump 66 to the control unit 56 of the cooking device 10. Additionally, in some examples, the control unit 56 may include a wireless transceiver 126 therein that may be operably coupled to the electronic device 88 in addition to or in lieu of a dedicated wireless transceiver 126 within the spritzer assembly 60. The electronic device 88 may be operably coupled with one or both of the transceivers 126 and a common or different application 128 may be used on the electronic device 88 depending on which the transceiver 126 of the electronic device 88 is communicating with. Likewise, the control unit 56 may also include the input device 84 in addition to or in lieu of the spritzer assembly 60. As provided herein, the frequency and/or duration of the activation of the pump 66 may be altered through any electronic device 88 and/or any input device 84 that is operably coupled with the spritzer assembly 60.

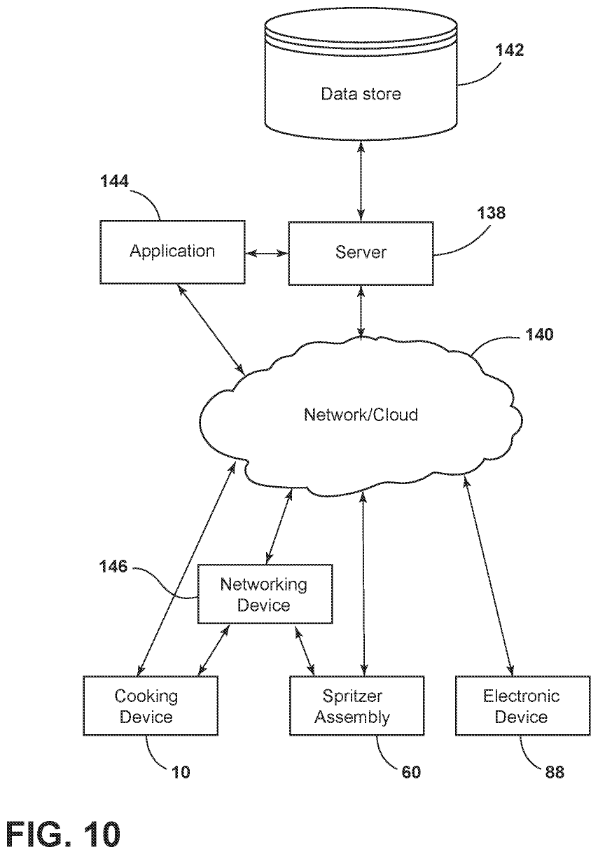

Referring to FIG. 10, in some examples, the cooking device 10 and/or the spritzer assembly 60 may be communicatively coupled with one or more remote sites such as a remote server 138 via a network/cloud 140. The network/cloud 140 represents one or more systems by which the cooking device 10 and/or the spritzer assembly 60 may communicate with the remote server 138. Accordingly, the network/cloud 140 may be one or more of various wired or wireless communication mechanisms, including any desired combination of wired and/or wireless communication mechanisms and any desired network topology (or topologies when multiple communication mechanisms are utilized). Exemplary communication networks 140 include wireless communication networks (e.g., using Bluetooth, IEEE 802.11, etc.), local area networks (LAN) and/or wide area networks (WAN), including the Internet and the Web, which may provide data communication services and/or cloud computing services. The Internet is generally a global data communications system. It is a hardware and software infrastructure that provides connectivity between computers. In contrast, the Web is generally one of the services communicated via the Internet. The Web is generally a collection of interconnected documents and other resources, linked by hyperlinks and URLs. In many technical illustrations when the precise location or interrelation of Internet resources are generally illustrated, extended networks such as the Internet are often depicted as a cloud (e.g. 140 in FIG. 10). The verbal image has been formalized in the newer concept of cloud computing. The National Institute of Standards and Technology (NIST) provides a definition of cloud computing as “a model for enabling convenient, on-demand network access to a shared pool of configurable computing resources (e.g., networks, servers, storage, applications, and services) that can be rapidly provisioned and released with minimal management effort or service provider interaction.” Although the Internet, the Web, and cloud computing are not exactly the same, these terms are generally used interchangeably herein, and they may be referred to collectively as the network/cloud 140.

The server 138 may be one or more computer servers, each of which may include at least one processor and at least one memory, the memory storing instructions executable by the processor, including instructions for carrying out various steps and processes. The server 138 may include or be communicatively coupled to a data store 142 for storing collected data as well as instructions for operating the cooking device 10, the control unit 56 (FIG. 8), the spritzer assembly 60, etc. that may be directed to and/or implemented by the cooking device 10 and/or the spritzer assembly 60 with or without intervention from a user and/or the electronic device 88.

In some examples, the instructions may be inputted through the electronic device 88 and relayed to the server 138. Those instructions may be stored in the server 138 and/or data store 142. At various predefined periods and/or times, the cooking device 10 and/or the spritzer assembly 60 may communicate with the server 138 through the network/cloud 140 to obtain the stored instructions, if any exist. Upon receiving the stored instructions, the cooking device 10 and/or the spritzer assembly 60 may implement the instructions. The server 138 may additionally store information related to multiple cooking devices 10, food items, usage characteristics, errors, etc. and operate and/or provide instructions to the cooking device 10 and/or the spritzer assembly 60 in conjunction with the stored information with or without intervention from a user and/or the electronic device 88.

With further reference to FIG. 10, the server 138 also generally implements features that may enable the cooking device 10 and/or the spritzer assembly 60 to communicate with cloud-based applications 144. Communications from the cooking device 10 and/or the spritzer assembly 60 can be directed through the network/cloud 140 to the server 138 and/or cloud-based applications 144 with or without a networking device 146, such as a router and/or modem. Additionally, communications from the cloud-based applications 144, even though these communications may indicate one of the cooking device 10 and/or the spritzer assembly 60 as an intended recipient, can also be directed to the server 138. The cloud-based applications 144 are generally any appropriate services or applications 144 that are accessible through any part of the network/cloud 140 and may be capable of interacting with the cooking device 10 and/or the spritzer assembly 60.

In various examples, the electronic device 88 can be feature-rich with respect to communication capabilities, i.e. have built in capabilities to access the network/cloud 140 and any of the cloud-based applications 144 or can be loaded with, or programmed to have, such capabilities. The electronic device 88 can also access any part of the network/cloud 140 through industry standard wired or wireless access points, cell phone cells, or network nodes. In some examples, users can register to use the remote server 138 through the electronic device 88, which may provide access the cooking device 10 and/or the spritzer assembly 60 and/or thereby allow the server 138 to communicate directly or indirectly with the cooking device 10 and/or the spritzer assembly 60. In various instances, the cooking device 10 and/or the spritzer assembly 60 may also communicate directly, or indirectly, with the electronic device 88 or one of the cloud-based applications 144 in addition to communicating with or through the server 138. According to some examples, the cooking device 10 and/or spritzer assembly 60 can be preconfigured at the time of manufacture with a communication address (e.g. a URL, an IP address, etc.) for communicating with the server 138 and may or may not have the ability to upgrade or change or add to the preconfigured communication address.

Referring still to FIG. 10, when a new cloud-based application 144 is developed and introduced, the server 138 can be upgraded to be able to receive communications for the new cloud-based application 144 and to translate communications between the new protocol and the protocol used by the cooking device 10 and/or the spritzer assembly 60. The flexibility, scalability and upgradeability of current server technology renders the task of adding new cloud-based application protocols to the server 138 relatively quick and easy.

The cooking device of the present disclosure may offer a variety of advantages. For instance, use of the spritzer assembly provided herein may improve the flavor, tenderness, and/or color of a food item that is heated within the cooking device. The spritzer assembly may be used for a wide range of fluids that may be disposed on the food item while the food item is in a substantially closed chamber without having to open the chamber for further spritzing. The spritzer assembly provided herein may dispense fluid at a predetermined frequency and/or for a preset duration. Additionally or alternatively, the spritzer assembly may include an input device that allows a user to define the frequency and the duration of the spritzing. An electronic device may be used to determine the activation patterns of the spritzer assembly. The cooking device may further include an imaging system that may provide images to a display of the electronic device. Upon viewing the food item within the closed chamber, the user may determine whether or not to manually activate the spritzer assembly. The spritzer assembly may be a stand-alone unit that may be retrofit onto any desired cooking device and/or partially (or fully) integrated into a cooking device.

It will be understood by one having ordinary skill in the art that construction of the described invention and other components is not limited to any specific material. Other exemplary examples of the invention disclosed herein may be formed from a wide variety of materials unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable and/or physically interacting components and/or wirelessly interactable and/or wirelessly interacting components and/or logically interacting and/or logically interactable components.

It is also important to note that the construction and arrangement of the elements of the invention as shown in the exemplary examples is illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system might be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A spritzer assembly for a cooking device, the spritzer assembly comprising:
a reservoir configured to maintain a fluid therein;
a pump operably coupled with the reservoir, the pump configured to move the fluid from the reservoir and through a nozzle, wherein the nozzle is configured to be positioned within a heating chamber; and
a controller configured to selectively activate the pump.

2. The spritzer assembly of claim 1, wherein the controller is operably coupled with an electronic device and activation of the pump is altered through an application on the electronic device.

3. The spritzer assembly of claim 1, wherein the heating chamber is defined by a housing of a grill.

4. The spritzer assembly of claim 1, wherein the activation of the pump is varied based on a user-selected instruction.

5. The spritzer assembly of claim 1, further comprising:
a generator operably coupled with a power supply, the power supply providing power for at least one of the controller and the pump.

6. The spritzer assembly of claim 2, wherein the activation of the pump by the controller is varied through usage of the application.

7. The spritzer assembly of claim 1, wherein the activation of the pump is varied based on a food item disposed within the heating chamber.

8. The spritzer assembly of claim 1, further comprising:
an input device operably coupled with the pump and disposed on a control unit of the cooking device.

9. A cooking device comprising:
a housing defining a heating chamber and a void within the housing;
a spritzer assembly having a pump operably coupled with a reservoir and a nozzle, the nozzle disposed within the heating chamber and operably coupled to the pump through a tubing disposed through the void; and
a controller operably coupled with the pump and configured to selectively activate the pump to move a fluid from the reservoir through the nozzle.

10. The cooking device having the spritzer assembly of claim 9, further comprising:
a heating element within the heating chamber; and
a rack positioned within the heating chamber, the heating element disposed on a first side of the rack and the nozzle disposed on a second, opposing side of the rack.

11. The cooking device having the spritzer assembly of claim 9, wherein the controller is wirelessly coupled with an electronic device and the activation of the pump is altered through an application on the electronic device.

12. The cooking device having the spritzer assembly of claim 11, further comprising:
an imaging system optically coupled with the heating chamber, wherein images from the imaging system are disposed on the electronic device.

13. The cooking device having the spritzer assembly of claim 9, further comprising:
an input device disposed on a control unit and configured to selectively activate the pump for at least one of a predetermined duration and a predetermined time frequency.

14. The cooking device having the spritzer assembly of claim 13, wherein the input device includes a switch, the switch configured to activate the pump when toggled from a first state to a second state.

15. A spritzer assembly for a cooking device, the spritzer assembly comprising:
a reservoir configured to maintain a fluid therein;
a pump operably coupled with the reservoir, the pump moving the fluid from the reservoir and through first and second nozzles, wherein the first and second nozzles are configured to be positioned within a heating chamber and are fluidly coupled to one another; and
a controller configured to selectively activate the pump, the controller further configured to operably couple with an electronic device.

16. The spritzer assembly for the cooking device of claim 15, further comprising:
a generator operably coupled with a power supply, the power supply providing power for at least one of the controller and the pump.

17. The spritzer assembly for the cooking device of claim 15, wherein the first nozzle generates a first spray pattern and the second nozzle generates a second, differing spray pattern.

18. The spritzer assembly for the cooking device of claim 15, wherein the heating chamber is heated by a heat source positioned on an opposing side of a rack from the first or second nozzle.

19. The spritzer assembly for the cooking device of claim 18, wherein the heat source includes a heating element configured to ignite a plurality of pellets disposed within a hopper operably coupled with a housing defining the heating chamber to heat the heating chamber.

20. The spritzer assembly for the cooking device of claim 15, wherein at least one of a frequency and a duration of activation of the pump is altered based on an instruction accepted through the electronic device.
